(19) United States
(12) Patent Application Publication
(10) Pub. No.: US 2026/0149737 A1
(43) Pub. Date: May 28, 2026

(54) SYSTEMS AND METHODS FOR MEDIA ACCESS CONTROL (MAC) ADDRESS SPOOFING DETECTION

(71) Applicant: Bastille Networks, Inc., Santa Cruz, CA (US)

(72) Inventors: Nicola Bui, Mountain View, CA (US); Gurdit Chahal, Santa Cruz, CA (US); Colin Snyder, Santa Cruz, CA (US); Brandon Shroyer, Santa Cruz, CA (US); Kai Kuspa, Santa Cruz, CA (US); Rahul Nagraj, San Francisco, CA (US); Christian Sepulveda, San Mateo, CA (US)

(21) Appl. No.: 19/400,116

(22) Filed: Nov. 25, 2025

Related U.S. Application Data
(60) Provisional application No. 63/726,175, filed on Nov. 27, 2024.

(51) Int. Cl. H04L 9/40

(52) U.S. Cl. CPC H04L 63/1483

(57) ABSTRACT

Described herein are systems and methods for MAC address spoofing detection. That is, the system is configured to detect possible instances of MAC spoofing by devices attempting to connect with a network using a wireless or wired communication protocol (the same methods may also be applicable to detecting MAC spoofing by devices that are identified as already being connected to a network). To perform the MAC address spoofing detection, the system may establish “fingerprints” for any devices that are performing communications via the network. A fingerprint is an information representation of a particular device that is generated based on one or more characteristics of the device. A fingerprint provides an alternative mechanism for identifying a device instead of simply relying on an identifier for the device, such as a MAC address or other type of identifier, which may be more easily spoofed by a malicious actor.

### CROSS REFERENCE TO RELATED APPLICATIONS

This application claims priority to and benefit of U.S. provisional patent application No. 63/726,175 filed Nov. 27, 2024, which is herein incorporated by reference.

### BACKGROUND

A Media Access Control (MAC) address is a unique identifier assigned to a network interface controller (NIC) for use in network communications. The MAC address is used to identify devices on a network, like computers, smartphones, printers, and other devices that connect to the Internet or a local area network (LAN). MAC spoofing occurs when an “imposter” device spoofs, or fakes, its MAC address to impersonate the MAC address of another device. MAC address spoofing is an indicator of a potential cybersecurity concern. For example, a malicious device may use MAC address spoofing to gain access to a network that the malicious device may otherwise not be able to access.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates an exemplary system for MAC address spoofing detection, in accordance with one or more embodiments of the disclosure.

FIG. 2 illustrates another exemplary system for MAC address spoofing detection, in accordance with one or more embodiments of the disclosure.

FIGS. 3A-6 illustrate exemplary methods for MAC address spoofing detection, in accordance with one or more embodiments of this disclosure.

FIG. 7 illustrates an example of a computing system, in accordance with one or more embodiments of this disclosure.

### DETAILED DESCRIPTION

Described herein are systems and methods for MAC address spoofing detection. That is, the system is configured to detect possible instances of MAC spoofing by devices attempting to connect with a network using a wireless or wired communication protocol (the same methods may also be applicable to detecting MAC spoofing by devices that are identified as already being connected to a network). To perform the MAC address spoofing detection, the system may establish “fingerprints” for any devices that are performing communications via the network. A fingerprint is an information representation of a particular device that is generated based on one or more characteristics of the device. A fingerprint provides an alternative mechanism for identifying a device instead of simply relying on an identifier for the device, such as a MAC address or other type of identifier, which may be more easily spoofed by a malicious actor.

Generally, fingerprinting is used as follows to verify the identity of a given device. Initially, a ground truth fingerprint is pre-generated for a MAC address (used by a device performing communications or attempting to perform communications using the MAC address), and the ground truth fingerprint represents the characteristics of the real, non-spoofed device associated with the MAC address. This ground truth fingerprint may then be stored as a frame of reference as an entry in a data storage medium (e.g., any long-term data storage mechanism, such as a database, short-term data storage mechanism, such as cache, etc.), along with the associated MAC address. When a device subsequently attempts to perform communications with the network using the same MAC address, a new fingerprint is generated for that device. This fingerprint is then compared to the ground truth fingerprint (with the ground truth fingerprint serving as a frame of reference for what the characteristics of a device associated with the MAC address should be) to determine if the device attempting to perform communications is the same, known non-spoofing device associated with the ground truth fingerprint. For example, if there is more than a threshold difference between the fingerprint and ground truth fingerprint, then it may be determined that the device is spoofing the MAC address (because the characteristics used to produce the fingerprints should be the same, or at least substantially similar, if the communications are performed by the same device).

Any number of different types of characteristics may be used to establish a fingerprint for a device. The specific characteristics that are used to generate these fingerprints may vary depending on certain factors, such as the type of device and/or the communication protocols (e.g., Wi-Fi, Bluetooth, etc.) being used for communications, among other factors. Accordingly, different characteristics may be used for each of the four types of MAC spoofing listed above. While the list of characteristics may not necessarily always be the same across devices in different scenarios, the spoofing determination may still be performed as long as there is overlap between the ground truth fingerprint and the fingerprint generated in real-time as the spoofing assessment is being performed by the system for a device attempting to perform communications with the network (to allow for a proper comparison of the two fingerprints for spoofing detection, as is described in further detail below). However, this is not intended to be limiting and some or all of the same characteristics may be used to establish fingerprints for multiple different types of spoofing detection techniques.

While the system may generally leverage fingerprinting to identify a spoofed MAC address, the system may, in some instances, use specific techniques depending on the wireless communication protocol in use and/or the type of device that is performing the communications, among other factors. Accordingly, the system may also be configured to apply one of several different techniques for identifying when MAC spoofing is occurring. For example, the system may be configured to detect MAC spoofing for numerous different scenarios, such as: (1) spoofing of a Wi-Fi router or access point, (2) spoofing of a Wi-Fi client, (3) spoofing of a paired Bluetooth or Bluetooth Low Energy (BLE) device, or (4) spoofing of an unpaired Bluetooth or BLE device. These four examples are not intended to limit the scope of the spoofing detection system. The system may also be configured to detect spoofing for any other type of device performing communications using any other wireless (or wired) communication protocol.

Turning now to the first scenario mentioned above, the system may detect MAC address spoofing of a Wi-Fi router or access point (that is, a device attempting to spoof as a Wi-Fi router or access point in the network) using multiple different techniques. A first technique involves the system periodically analyzing data received from devices to establish ground truth fingerprints for each Wi-Fi router or access point in the network. That is, initial ground truth fingerprints may be generated for any Wi-Fi routers or access points based on characteristics identified for known non-spoofed devices, as explained above. For example, this initial ground truth fingerprinting process may be performed when a new Wi-Fi router or access point is added to the network. As a further verification mechanism, the system may prompt a user who installed the Wi-Fi router or access point to confirm that the Wi-Fi router or access point was intentionally added to the network.

In one or more embodiments, the characteristics that are used for establishing a fingerprint for detecting spoofing of a Wi-Fi router or access point may include elements of a beacon frame that is transmitted by the device. Generally, a beacon frame in Wi-Fi is a type of management frame that is transmitted periodically by a wireless access point to announce the presence of a wireless network. For example, the attributes of the beacon frame that are considered may include encryption, authentication, information element, vendor-specific information, vendor-specific type information, channel, wireless capabilities, message count statistics, information element lists, etc. These beacon frames may also be analyzed by the system to understand the device's wireless capabilities. For instance, the system may use the data to determine the communication protocols that a device is configured to use (e.g., 802.11 a/b/g/ac/n, etc.). However, these characteristics are merely exemplary and any other characteristics may also be used.

In this first technique, the system may continue to periodically update the ground truth fingerprints for the devices over time, as it is possible for characteristics to change over time. As one non-limiting example, the system may perform this analysis and update any ground truth fingerprints every 60 minutes, however, other time intervals may be used instead. The system may alternatively trigger the update process for existing ground truth fingerprints based on conditions other than time as well. Another exemplary triggering condition may be a manual indication by a user that the ground truth fingerprints should be updated. Another exemplary triggering condition may be a firmware and/or other type of update having been performed on a device. Another triggering condition may be that the system detected that the device was temporarily removed from the network and added back to the network (for example, the device may be temporarily shut down to perform a hard reset of the device, or the device may be shut down or otherwise removed from the network for any other purpose). These are merely examples of additional triggering conditions for updating ground truth fingerprints and any other conditions (or combination of conditions) may be used. It is not necessarily required for the ground truth fingerprints to be updated over time, and the initial ground truth fingerprints may serve as the permanent ground truth for the devices.

Once any ground truth fingerprints are generated, the ground truth fingerprints may be stored (for example, in a database or any other storage medium) in association with the MAC address. For example, if a ground truth fingerprint is stored in a database, there may be an entry in the database for the MAC address and the ground truth fingerprint generated for that MAC address. In instances in which a ground truth fingerprint is updated (as described above), the original entry for that ground truth fingerprint may be replaced with the updated ground truth fingerprint. In some cases, it may be desirable to still maintain one or more of the prior ground truth fingerprints in the data storage (for example, for system troubleshooting purposes, to perform an analysis to determine if the changes to the ground truth fingerprints over time indicate abnormal changes, etc.).

In one or more embodiments, any of this data that is analyzed by the system may be recorded as a monotonically increasing time series. By recording the data in this manner, the system can effectively collect statistics and other information relating to flow, such as the number of impressions observed in a time window, interarrival time statistics, message size distribution, etc. The data may also be recorded in any other suitable format other than a monotonically increasing time series as well.

Once the system has completed a given number of computation cycles in which data is collected and fingerprints are generated (as a non-limiting example, this number may be two computation cycles), the system may analyze any collected data and may assign a spoofing score for the device performing communications. The analysis and score assignment may be performed in the following manner, for example (however, this approach is not intended to be limiting). First, for information element lists, vendor type, and vendor-specific information, a rank-based overlap similarity may be computed that compares the rank order of the given attributes. For example, the ranked list of the most common sequence tags of current and stored fingerprints may be compared. Second, for message count statistics, the ratios between means and standard deviations may be compared, where the numerator is the minimum coefficient between the two and the denominator is the maximum. Third, for the remainder of the attributes, it may be considered whether there is overlap among the attributes of the current and stored ground truth fingerprints. The comparison(s) may also be performed in any other suitable manner.

As one non-limiting example, the spoofing score may be a score that falls within a pre-designated range of values (such as 0 to 1) by analyzing the difference in attributes between real time data and the stored fingerprint. For each potential MAC spoofing detection generated by the system, it assigns this score, where 0 denotes very unlikely that spoofing is occurring and 1 denotes highly likely that spoofing is occurring. This range of values is merely exemplary and any other range of values may be used. Additionally, although reference is made to a higher score being more indicative of spoofing, the opposite may also be true, depending on the specific system configuration.

In one or more embodiments, a spoofing score may be generated for each of these three analyses. For example, the spoofing score may be a numerical value within a pre-determined range of potential values, however, the spoofing score may also be provided in any other form. The three scores may then be combined using a weighted average. The three scores may also be combined in any other suitable manner.

Finally, the system may compare this combined spoofing score to a threshold value to determine if the device is spoofing its MAC address. If the combined spoofing score satisfies the threshold value, then the system may determine that the device is spoofing the MAC address. Whether the combined spoofing score satisfies the threshold value may vary depending on the implementation. “Satisfying” the threshold value may refer to the combined spoofing score being greater than, greater than or equal to, less than, or less than or equal to the threshold value. For example, if the system is configured such that a larger combined spoofing score is indicative of a device that is likely spoofing its MAC address, then satisfying the threshold may refer to the MAC address being greater than or greater than or equal to the threshold. However, if the system is configured such that a smaller combined spoofing score is indicative of a device that is likely spoofing its MAC address, then satisfying the threshold may refer to the MAC address being less than or less than or equal to the threshold. These exemplary threshold comparison options may also be applicable to any other threshold comparisons described herein.

In one or more embodiments, the second approach involves the system analyzing any incoming communications from devices in real-time. With this approach, the system can flag a device as having a spoofed MAC address by considering beacon frames. This data may include some or all of the different information element lists being transmitted by the same device within a data observation window. If more than one of such lists is detected, the system may compute the normalized Indel similarity (other techniques may also be used) may be computed. If the difference is larger than a threshold, then the device may be flagged as a potential spoofing device.

Turning to the second scenario listed above, the system may detect spoofing of a Wi-Fi client in a similar manner in which the system detects spoofing of a Wi-Fi router or access point. That is, the system may periodically (for example, every 60 minutes or any other period of time) collect and analyze data from devices to establish Wi-Fi client fingerprints. These fingerprints may then be stored (for example, in a database or any other storage medium) in association with the MAC address as ground truth data. After the fingerprints are established and stored, when any subsequent communications are received from a device, a current fingerprint for the communicating device is established. The system may then identify the MAC address that the communicating device is providing (which may be spoofed or real) and the current fingerprint for the communicating device is compared to the stored fingerprint for the known device associated with the MAC address.

While the approach may generally be the same, the characteristics for detecting spoofing of a Wi-Fi client may differ. In one or more embodiments, the characteristics that are used for establishing a fingerprint for detecting spoofing of a Wi-Fi client may include elements of the following frames: “Data,” “QoS Data,” “Null,” “QoS Null,” “Data+CF-Ack,” and/or “QoS Data+CF-Ack”. For one or more of these frames, the system may analyze the following attributes: channel, wireless capabilities, message count statistics, and/or frame type distribution. These frames may also be analyzed to understand the wireless capabilities of the device. For instance, the information in the frames may be used to determine the wireless protocol(s) that the device is configured for (e.g., 802.11 a/b/g/ac/n, etc.).

Any of this data that is analyzed by the system may be recorded as a monotonically increasing time series. By recording the data in this manner, the system can effectively collect statistics and other information relating to flow, such as the number of impressions observed in a time window, interarrival time statistics, message size distribution, etc. The data may also be recorded in any other suitable format other than a monotonically increasing time series as well.

Once the system has completed a given number of these computation cycles (as a non-limiting example, this number may be two computation cycles), the system may analyze any collected data and may assign a spoofing score for the device performing communications. Computing the spoofing score in this scenario may involve computing a programmatic statistical digest of each cycle, and then computing the Jaccard similarity between digests from two (or more) different cycles. However, other techniques for determining the spoofing score may also be used. To determine if a device should be flagged as potentially spoofing its MAC address, the Jaccard similarity score may be compared to a threshold value. If the Jaccard similarity score falls below the threshold, then the device may be flagged as potentially spoofing its MAC address (however, other types of comparisons with the threshold value may also be made, as described above with respect to the first scenario).

Turning to the third scenario listed above, the system may detect spoofing of a paired Bluetooth device by training a machine learning model (or any other type of model) to perform any of the analyses described above with respect to any of the scenarios (or any other types of communication protocols, devices, etc. not mentioned herein). The machine learning model may be used to generate the fingerprints that are then stored as ground truth for known devices. An inference step then buffers subsequent data received from devices, establishes current fingerprints for the devices, and compares the current fingerprints to known fingerprints associated with the MAC addresses stored in memory to determine if a device is potentially spoofing its MAC address. It should be noted that the use of a machine learning model (or other type of model) is not necessarily limited to spoofing detection of Bluetooth devices and may also be used to detect spoofing of devices communicating via Wi-Fi (or any other communication protocol) as well.

In one or more embodiments, the characteristics that are used for establishing a fingerprint for detecting spoofing of a paired Bluetooth device may include elements of Bluetooth data frames. The attributes of these frames that are analyzed may include, for example, frame size, message count, and/or interarrival times.

In one or more embodiments, the model training may be performed as follows. For each device, any data that is obtained may be grouped into non-overlapping sequences of a given sample size (for example, 24 samples or any other number of samples). A sample may be, for example, a wireless observation. Wireless observations may include, for example, a device ID, a timestamp, a protocol, a position, etc. Then there are additional fields, however, these fields vary with protocol and the device behavior at the time of the observation. Pairs may then be created by permuting sequences from each device with that device's own sequences and with other devices'sequences. These pairs may be provided as inputs to the trained machine learning model (as one non-limiting example, random forest), which learns to identify whether two sequences of a pair are from the same device.

During the inference stage (after the model has been trained and is being used to detect potential spoofing attempts), the system buffers incoming data (for example, communications received from devices) until the system has the sequences with the pre-determined number of samples (continuing the prior example, this would be the 24 sample sequences), at which point the data may be provided to the model. For each new sequence, the model infers whether a device is attempting to spoof a MAC address by scoring the most recent sequences and comparing the score to a threshold value (in a similar manner described with respect to the other scenarios).

In some instances, the system may limit the number of sequences and transmitters/devices to be considered during the machine learning algorithm training phase and/or the inferencing phase in order to achieve a deterministic memory footprint, which may be a constraint for operating in virtualized air gapped appliance-like environments. That is, there may be memory constraints within the system, so it may not always be feasible to consider all possible sequences during the model training. For example, the system may prioritize devices that have been the most active in the evaluation window. Additionally, the system may choose a fixed length of sequences for each device selected for training (and/or subsequent to training during inferencing) based on the total available memory in the virtual machine that the app runs in.

Turning to the fourth scenario listed above, the system may detect spoofing of an unpaired Bluetooth device by analyzing data received from devices and caching relevant attributes for each device. When the system detects a change in attributes, the device may be flagged as potentially spoofing its MAC address. The characteristics that are used for establishing a fingerprint for detecting spoofing of an unpaired Bluetooth device may include elements of Bluetooth FHS messages and BLE advertisements. The attributes of these frames may include, for example, device class, service, major category, minor category, device name, and/or device universally unique identifiers (UUIDs).

In one or more embodiments, a thresholding mechanism may apply to the spoofing score to improve the reliability of the prediction. That is, a confidence threshold may be applied to the spoofing score to trigger a detection. The spoofing score may be compared against a user-configurable threshold. This is because different environments have different variations in RF attributes.

While reference is made to specific techniques being used to detect spoofing in different scenarios (for example, different techniques for devices communicating using Wi-Fi protocols, Bluetooth protocols, etc.), these techniques are not necessarily limited to that particular scenario and may be applied in other scenarios as well. For example, the technique described as being used to detect spoofing for Wi-Fi clients may also be used to detect spoofing for Bluetooth paired devices (however, the characteristics used for the fingerprints may still differ, given the different packet types and information included in the packet for the different communication protocols) and vice versa.

An alternative technique to identify MAC spoofing operates on the principle that every wireless transmitter has a unique, unintentional “electromagnetic wave fingerprint” due to minute imperfections in its hardware components from the manufacturing process. This technique works at the physical signal level characteristics and not on the MAC address or protocol decoding/message content level. With this approach, the system may consider (but is not limited to): (i) Carrier Frequency Offset (CFO), which is the small, consistent deviation between a device's actual transmission frequency and its intended, or nominal, frequency. (ii) IQ imbalance in-phase (I) and Quadrature (Q) imbalance, which refers to imperfections in the signal modulation process. (iii) Phase Noise, which describes the rapid, random fluctuations in the phase of a signal's carrier wave. An ideal oscillator would produce a signal with a perfectly stable phase, but real-world oscillators introduce these small, jittery variations.

It should be noted that three scenarios where the imposter device and the device being spoofed are: (i) both active and present in the site under observation, (ii) only the imposter is present, and (iii) only the device being spoofed is present but we have historical information about an erstwhile imposter device That is, one of the benefits of the systems and methods described herein is that the spoofing detection may be performed even if both of the devices are not present.

Additionally, although certain techniques for detecting spoofing are described herein, other techniques may also be used. As one non-limiting example, a transformer architecture may be used and/or an attention head classifier may be fine-tuned to this particular use case.

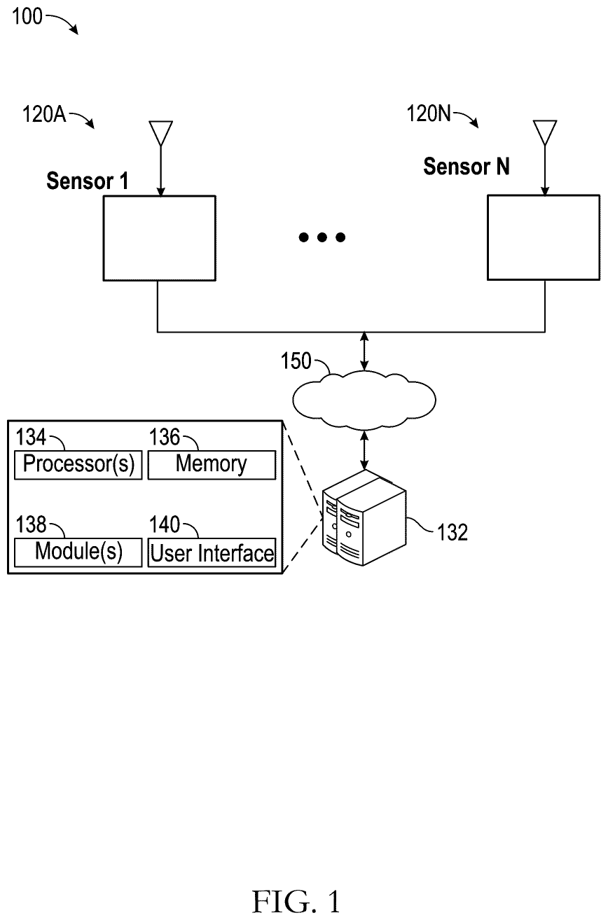

Turning to the figures, FIG. 1 illustrates an example system 100, in accordance with one or more embodiments of the disclosure. The system may include one or more sensors, such as sensors 120A . . . 120N (the sensors may be referred to herein as “sensors 120”). The one or more sensors 120 may be dispersed within a given environment and may constantly or periodically monitor signal transmissions from devices within the environment. That is, the sensors 120 may be configured to monitor communications for purposes of generating fingerprints (including ground truth and current fingerprints) for the devices to perform MAC address spoofing detection as described herein.

In some embodiments, the sensors 120 may be software defined radio (SDR) sensors. The sensors 120 may include at least multiple scanning 802.11 Wi-Fi receivers, multiple SDR receivers front ends that can each sample at 61.44 MSps and sense from 25 MHz to 6 GHz, and/or an array of bespoke internal antennas that may be optimized to maximize detection and localization performance. However, this is just one non-limiting example of a specific type of sensor that may be deployed, and the sensors 120 may be configured with any other types of hardware and signal detection capabilities as well.

Any of the information captured by the sensors 120 may be transmitted to the computing systems 132 (if the computing system(s) 132 are located externally to the sensors 120). The computing systems 132 may be responsible for performing certain tasks associated with MAC address spoofing detection as described herein, such as generating ground truth and current fingerprints, performing any comparisons between ground truth and current fingerprints, and/or any other tasks associated with MAC address spoofing detection as described herein.

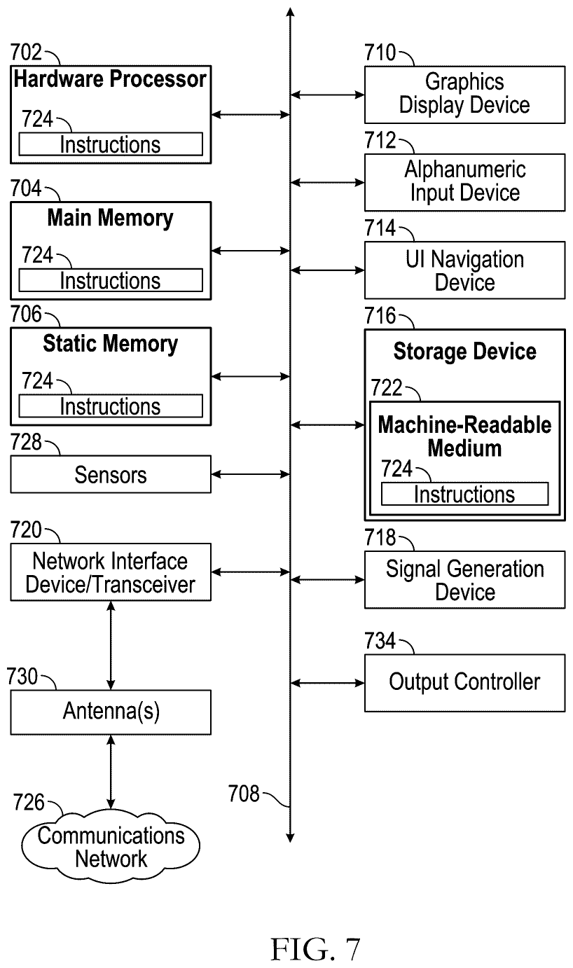

In one or more embodiments, the information may be transmitted over a communications network 150 using a transmission medium via the network interface device/transceiver utilizing any one of a number of transfer protocols (e.g., frame relay, internet protocol (IP), transmission control protocol (TCP), user datagram protocol (UDP), hypertext transfer protocol (HTTP), etc.). The communications network 150 may also be used to transmit information from the computing system(s) 132 to the sensors 120. For example, parameters established by an operator through the user interface 140 may be transmitted to the sensors 120 to adjust the filters of the sensors 120. The communications network 150 may also be used to transmit information between sensors 120 as well. Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. The communications network may be described in more detail with respect to the communications network 726 of FIG. 7.

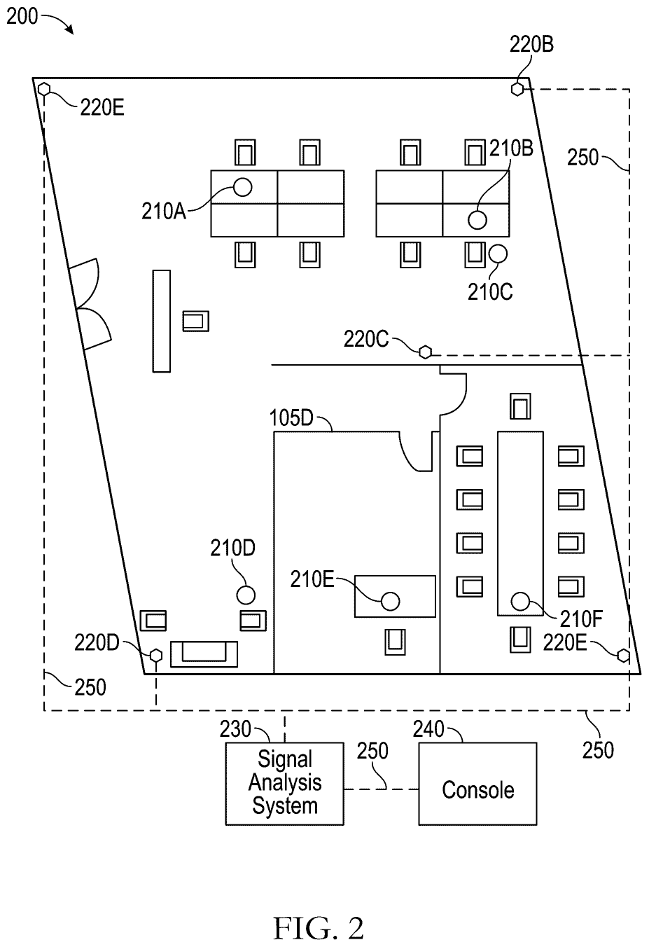

FIG. 2 is a block diagram depicting another system 200 (an implementation of the system 100 within a real-world environment). Wireless devices 210A-210F may each engage in communications within the real-world environment via any suitable wireless network or networks. Some or all of the wireless devices 210A-210F may be legitimate devices that are performing communications via the network or networks without malicious intent. However, in some cases, one or more of the wireless devices 210A-210F may be associated with malicious actors who are attempting to spoof a MAC address in order to gain access to a network for malicious purposes. For example, the wireless devices 210A-210F may be Wi-Fi routers or access points, Wi-Fi clients, paired Bluetooth or Bluetooth Low Energy (BLE) devices, and/or unpaired Bluetooth or BLE, however, any other type of device may be applicable. Although a specific number of wireless devices 210A-210F are shown in FIG. 1, this number of wireless devices 210A-210F is merely exemplary and any other number of wireless devices 210A-210F may exist in the environment. Additionally, the depicted positions of each of the wireless devices 210A-210F is merely exemplary. Furthermore, although the environment is shown as the interior of a building in FIG. 2, the same techniques may also be applicable to detect MAC address spoofing performed by devices that are located outside of a building as well (for example, a device may attempt to perform communications with devices inside a building from outside of the building).

The technology presented herein can collect and analyze any signals generated by the wireless devices 210A-210F. Sensors 220A-220E (which may be the same as, or similar to, sensors 120 described with respect to FIG. 1) positioned within collection areas 205A-205E can collect and report such signals (as well as any other information as described herein) within the surrounding environment. A signal analysis system 230 (which may be the same as, or similar to, the computing system(s) 132 shown in FIG. 1) can process the collected communications. A console 240 can provide a user interface for configuring, controlling, or reviewing analysis results associated with the signal analysis system 230. As aforementioned, the user interface may also allow the user to configure parameters used by the sensors 220A-220E, may present alerts to a user, may provide an indication of a source of a short pulse microwave signal (or any other signal), and/or may provide any other types of functionality for a user. One or more networks 250 (which may be the same as network 150 described with respect to FIG. 1, and/or any other network described herein) may interconnect some or all of the sensors 220, the signal analysis system 230, and the console 240.

The sensors 220A-220E may be referred to, in general or collectively, as sensors 220 or a sensor 220. The sensors 220 may collect electromagnetic signals from one or more antennas over a wide bandwidth of radio frequencies. The sensors 220 may utilize hardware radio receivers or software-defined radio frequency receivers. According to various embodiments, these radio receivers can convert received radio frequency energy into digital signals. These digital signals can then be decoded into encoded data streams. The sensors 220 may be the same as sensors 120 and/or any other sensors described herein.

While hardware-defined radio receivers can be cost-effective and less complex to implement, they may be limited as to what type of encoded data streams they can detect from the electromagnetic environment. For example, a hardware Wi-Fi receiver module or chipset is generally not able to receive mobile telephone radio signals. In contrast, software-defined radio receivers are more flexible and can receive and decode various data streams within the electromagnetic environment under software control. The signal data collected by the sensors 220 may be transmitted to the signal analysis system 230 for processing. These signals or related signal data may be communicated in a continuous fashion or in one or more batches, at particular intervals according to various embodiments.

The signal analysis system 230 can receive and process signals from the sensors 220. The signal analysis system 230 may perform, among other functions, raw signal analysis, signal aggregation, multiple-input antenna processing, space-time-frequency analysis, geolocation, link pair association, throughput estimation, classification, attack analysis, and various other types of signal processing and analysis. The signal analysis system 230 may comprise a signal aggregation and analysis engine comprised of one or more feature vector processors.

The signal analysis system 230 may be comprised of multiple systems that perform different portions of analysis and pass signals between each other in various formats over various communication links of the networks 250. For example, the signal analysis system 330 may comprise a complex and flexible network of various processing devices, which may be distributed to certain degrees or layered in a hierarchical system, to analyze and process the signals from the sensors 220.

The console 240 and various associated operator interfaces can support configuring, controlling, or reviewing analysis results associated with the signal analysis system 230. The console 240 can provide visualization features for use by security administrators to monitor the electromagnetic environment for MAC address spoofing attempts. The operator interfaces may comprise interfaces associated with one or more visualization consoles 240, one or more administrative user interface application, or various other user or system interfaces associated with the technology presented herein. For example, the operator interfaces may present an alert when a MAC address spoofing attempt is detected. The operator interfaces may also provide any other relevant information, such as information about the device that is performing the spoofing attempt, the location of the device, the time of the spoofing attempt, etc.

The networks 250 may interconnect some or all of the sensors 220, the signal analysis system 230, and the console 240. Portions of the networks 250 connecting the sensors may be configured to transmit radio frequency signals and/or digital information. Radio frequency signals may be communicated as collected, down-converted using an intermediate frequency oscillator, or down-converted to baseband. Communication links associated with the networks 250 may use various physical media such as twisted pair, coaxial cable, or fiber optic cables. The signals transferred on the physical media may be analog RF, radio over fiber, digital, packetized, switched, connection-oriented, or any combination thereof. According to various embodiments, the communication links associated with the networks 250 may use wireless frequencies or transmission paths that are selected to avoid interference from or to the electromagnetic environment in use by the wireless devices 210.

It should be appreciated that, according to certain embodiments, the wireless devices 210 may also make use of the networks 250. According to certain other embodiments, the wireless devices 210 may be dissuaded or precluded from sharing the networks 250 with the signal collection and analysis systems presented herein and instead may connect to one or more production networks that are separate from the networks 250 associated with the sensors 320 and/or the signal analysis system 230.

The sensors 220, or the antennas associated therewith, may be physically distributed around an area under surveillance. The collective coverage provided by the sensors 320 may define the effective extent of the area under surveillance. According to some examples, the sensors 220 may be positioned uniformly on a grid pattern throughout the area under surveillance. The grid may be a square grid, hexagonal grid, or other distributed pattern. The spatial period of the distribution pattern may be related to a coverage distance associated with each sensor 220. The periodic positioning of the sensors 220 may be altered to accommodate structures within the environment, such as walls, stairwells, mechanical systems, and so forth. The periodic positioning of the sensors 220 may be altered to accommodate infrastructure feeds such as power and interface points for the network 250. For example, the interface points for the network 250 might be Ethernet ports.

The wireless devices 210, sensors 120, signal analysis system 230, console 240, or any other systems associated with the technology presented herein may be any type of computing machine, such as, but not limited to, those discussed in more detail with respect to FIG. 7. Furthermore, any modules associated with any of these computing machines or any other modules (scripts, web content, software, firmware, or hardware) associated with the technology presented herein may be any of the modules discussed in more detail with respect to FIG. 7. The devices and computing machines discussed herein may communicate with one another as well as other computer machines or communication systems over one or more networks, such as network 250. The network 250 may include any type of data or communications links or network technology, including any of the network technology discussed with respect to FIG. 7.

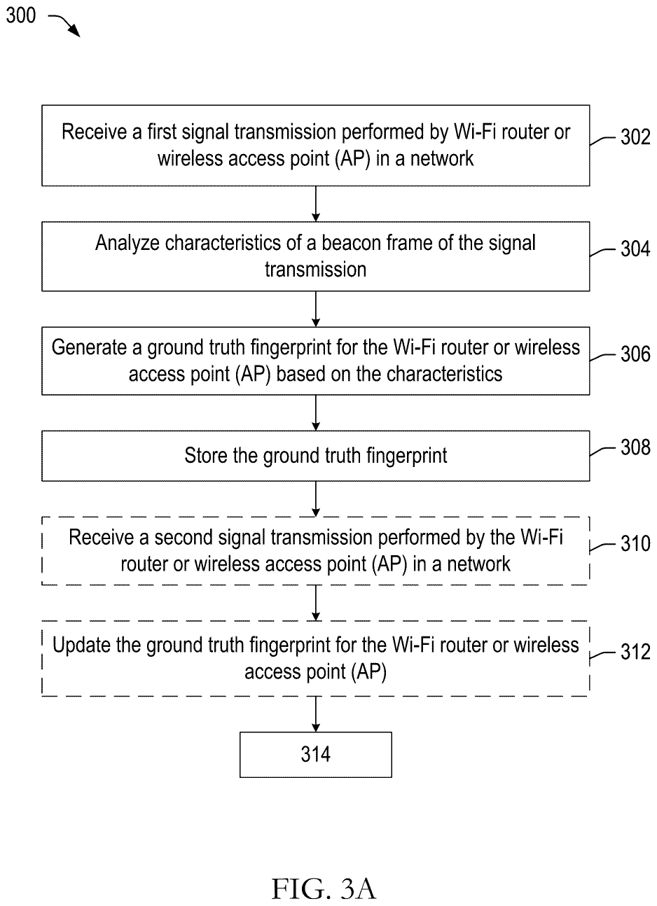

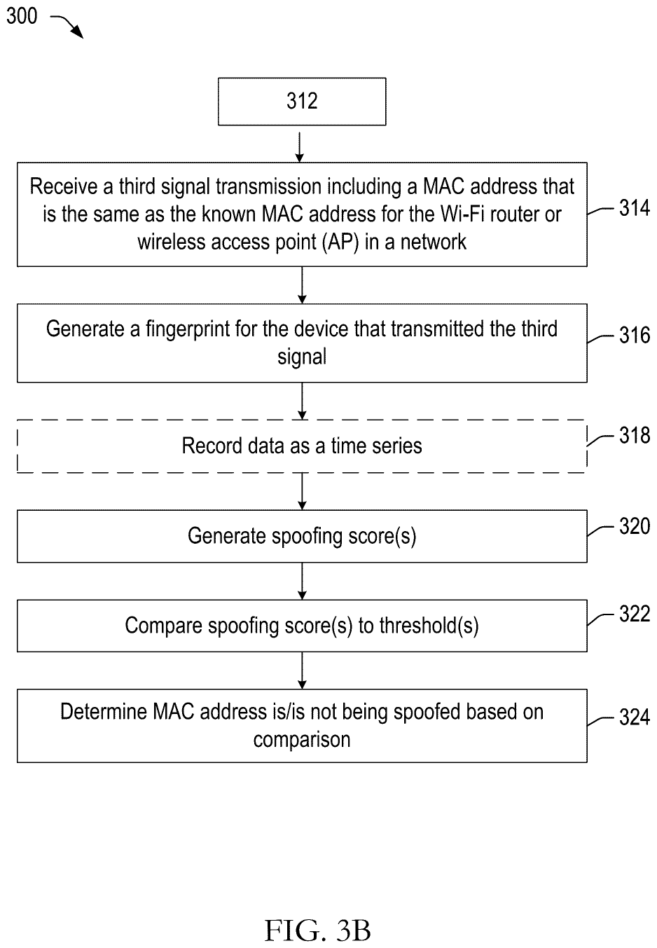

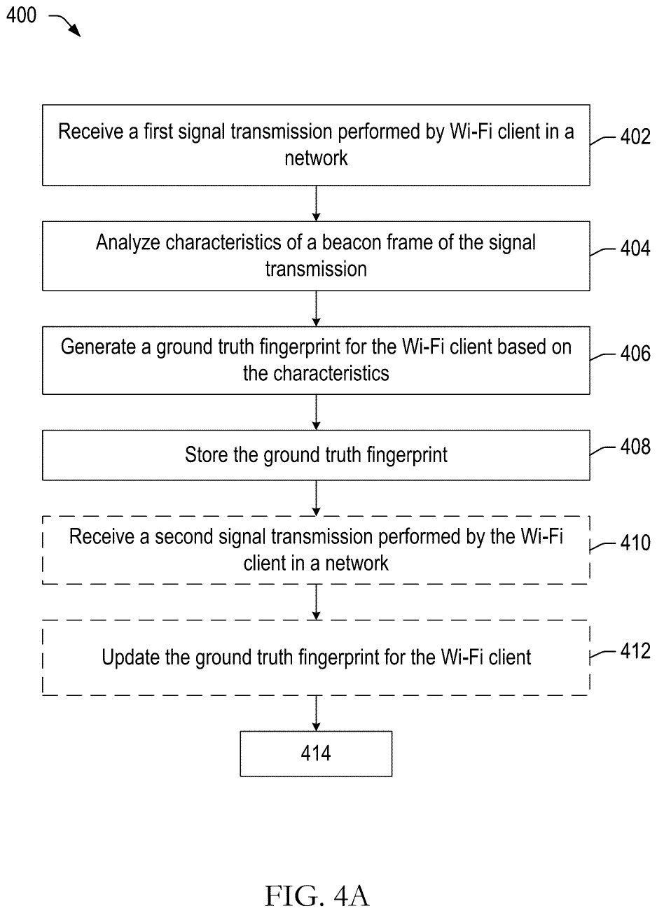

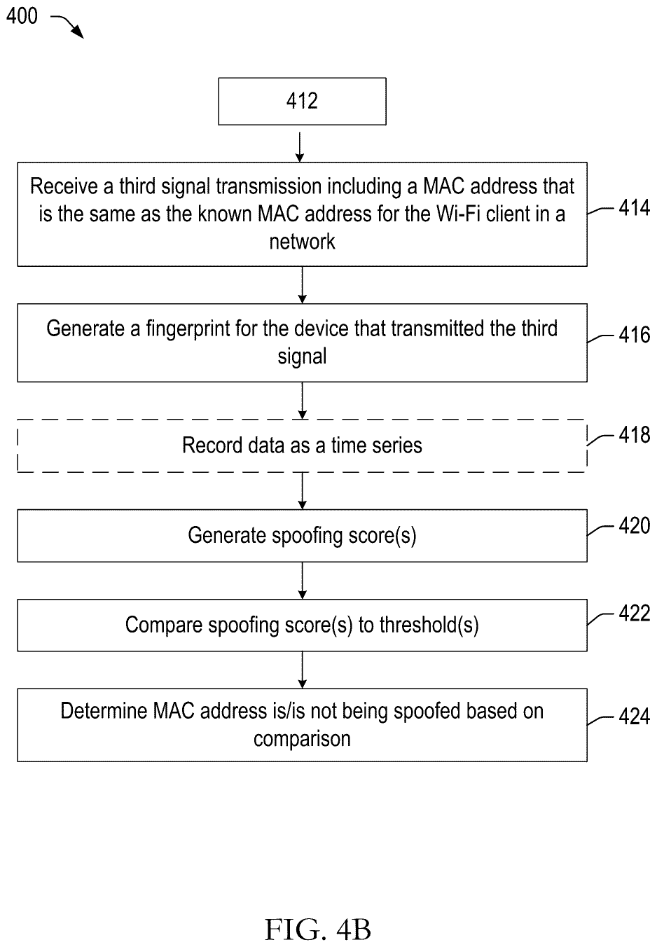

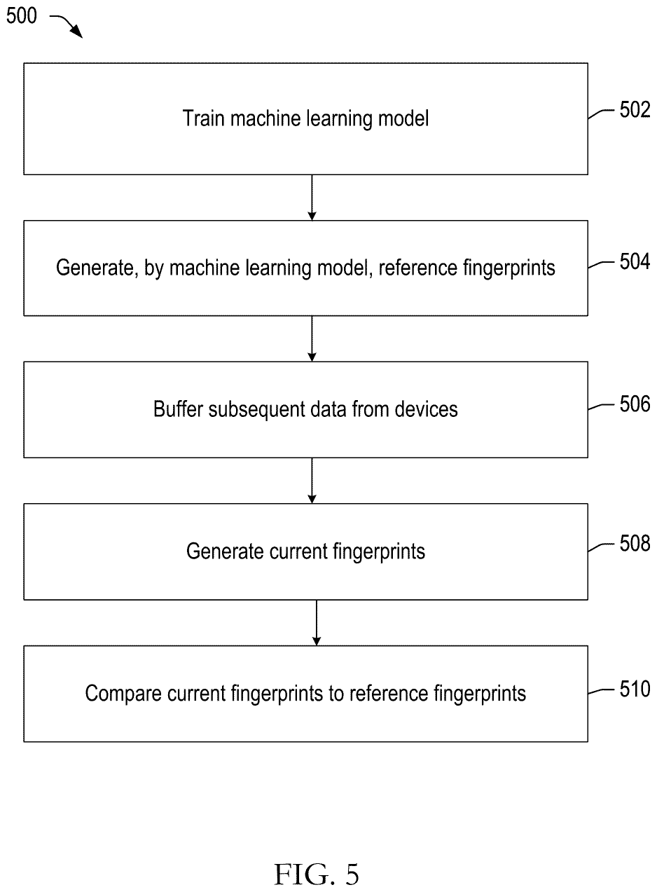

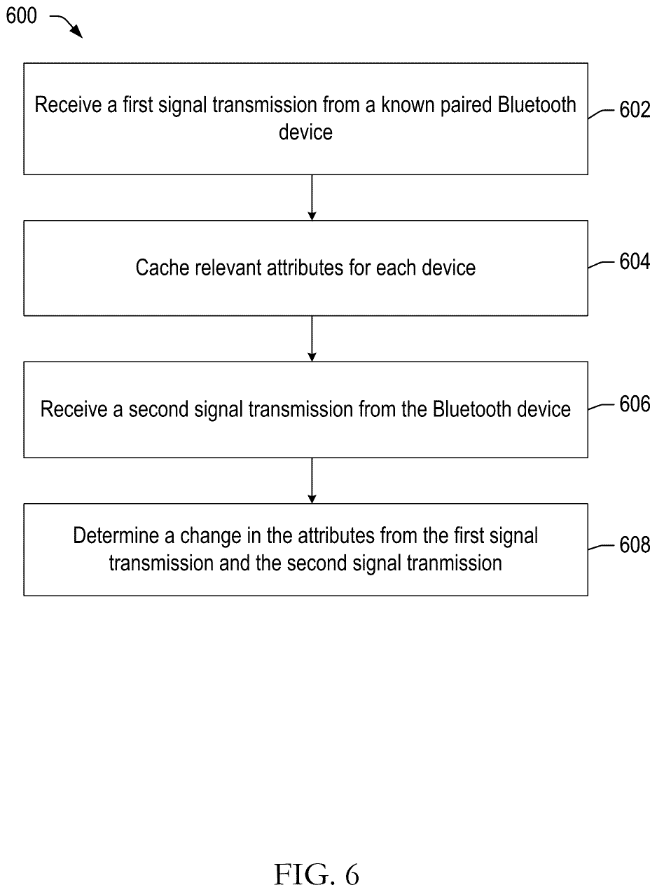

FIGS. 3A-6 illustrate exemplary methods for MAC address spoofing detection. Specifically, FIGS. 3A-3B illustrate a method 300 for spoofing detection for Wi-Fi routers and/or wireless access points, FIGS. 4A-4B illustrate a method 400 for spoofing detection for Wi-Fi clients, FIG. 5 illustrates a method 500 for spoofing detection for paired Bluetooth devices, and FIG. 6 illustrates a method 600 for spoofing detection for unpaired Bluetooth devices. As described above, some or all of these methods may involve generating fingerprints based on different device characteristics for devices accessing a network. However, the characteristics that are used for fingerprint generation, as well as some of the analysis steps for the different types of devices may differ, in some instances. It should be noted that the methods shown in FIGS. 3A-6 are merely exemplary and other approaches described herein or otherwise are possible. Additionally, for each of the methods, there may be fewer or a greater number of steps or each of the steps may be performed in any suitable order other than the order shown in the figures. Finally, as explained above, while reference is made to specific techniques being used to detect spoofing in different scenarios (for example, different techniques for devices communicating using Wi-Fi protocols, Bluetooth protocols, etc.), these techniques are not necessarily limited to that particular scenario and may be applied in other scenarios as well. For example, the technique described as being used to detect spoofing for Wi-Fi clients may also be used to detect spoofing for Bluetooth paired devices (however, the characteristics used for the fingerprints may still differ, given the different packet types and information included in the packet for the different communication protocols) and vice versa.

Beginning with FIGS. 3A-3B, an exemplary method 300 for spoofing detection for Wi-Fi routers and/or wireless access points is shown. Operation 302 of the method 300 involves receiving a first signal transmission performed by a Wi-Fi router or wireless access point in a network. For example, sensors (such as sensors 120, 220, etc.) may be disposed at one or more locations within an environment in which the network exists. The sensors may be configured to monitor for signal transmissions within the environment. “Receiving” a first signal transmission may indicate that a sensor detects that a signal has been transmitted by a Wi-Fi router or a wireless access point in the network (not necessarily that the signal is transmitted from the Wi-Fi router or the wireless access point directly to the sensor).

Operation 304 involves analyzing characteristics of a beacon frame of the signal transmission. For example, the analysis may be performed by the computing system(s) 132, signal analysis system 230, etc. that receives information about the signal from the sensor(s). Operation 306 involves generating a ground truth fingerprint for the Wi-Fi router or wireless access point based on the characteristics. For example, as mentioned above, characteristics of the beacon frame that are considered for a Wi-Fi router or wireless access point may include encryption, authentication, information element, vendor-specific information, vendor-specific type information, channel, wireless capabilities, message count statistics, information element lists, etc. These characteristics are merely exemplary and any other combination of characteristics may instead be considered. Operation 308 involves storing ground truth fingerprint for the device in data storage. For example, the MAC address for the device (Wi-Fi router or wireless access point) may be stored as an entry in a database along with the ground truth fingerprint generated for that device.

As explained above, the system may also, in some instances, optionally periodically update the ground truth fingerprint for a given device. Accordingly, optional operation 310 involves receiving a second signal transmission performed by the Wi-Fi router or wireless access point, and operation 312 involves updating the ground truth fingerprint for the Wi-Fi router or wireless access point.

Once the ground truth fingerprints are established, signal monitoring may be performed in real-time to perform MAC address spoofing detection as described herein. Operation 314 involves receiving a third signal transmission including a MAC address that appears to be the same as the MAC address for the Wi-Fi router or wireless access point for which the ground truth fingerprint was previously generated (the transmitting device could be the same device or may be a different device that is attempting to spoof the MAC address. Operation 316 involves generating a fingerprint for the device that transmitted the third signal. Optional operation 318 may involve recording data over time as a time series for signal transmission from the device.

As explained above, once the system has completed a given number of computation cycles in which data is collected and fingerprints are generated (as a non-limiting example, this number may be two computation cycles), the system may analyze any collected data and may assign a spoofing score (at operation 320) for the device performing communications. The analysis and score assignment may be performed in the following manner, for example (however, this approach is not intended to be limiting). First, for information element lists, vendor type, and vendor-specific information, a rank-based overlap similarity may be computed that compares the rank order of the given attributes. For example, the ranked list of the most common sequence tags of current and stored fingerprints may be compared. Second, for message count statistics, the ratios between means and standard deviations may be compared, where the numerator is the minimum coefficient between the two and the denominator is the maximum. Third, for the remainder of the attributes, it may be considered whether there is overlap among the attributes of the current and stored ground truth fingerprints. The comparison(s) may also be performed in any other suitable manner.

As one non-limiting example, the spoofing score may be a score that falls within a pre-designated range of values (such as 0 to 1) by analyzing the difference in attributes between real time data and the stored fingerprint. For each potential MAC spoofing detection generated by the system, it assigns this score, where 0 denotes very unlikely that spoofing is occurring and 1 denotes highly likely that spoofing is occurring. This range of values is merely exemplary and any other range of values may be used. Additionally, although reference is made to a higher score being more indicative of spoofing, the opposite may also be true, depending on the specific system configuration.

In one or more embodiments, a spoofing score may be generated for each of these three analyses. For example, the spoofing score may be a numerical value within a pre-determined range of potential values, however, the spoofing score may also be provided in any other form. The three scores may then be combined using a weighted average. The three scores may also be combined in any other suitable manner.

Finally, the system may compare this combined spoofing score to a threshold value (at operation 322) to determine if the device is spoofing its MAC address. If the combined spoofing score satisfies the threshold value, then the system may determine that the device is spoofing the MAC address at operation 324. Otherwise, the system may determine that the device is the original device and is not spoofing the MAC address.

As mentioned above, this is merely one potential approach for determining whether a Wi-Fi router or wireless access point is attempting to spoof a MAC address and other techniques may also be used. For example, rather than performing the three analyses mentioned above and determining spoofing scores for each, the analysis may entail a single comparison between the current fingerprint for the MAC address associated with the current transmission and the pre-established ground truth fingerprint for the same MAC address.

Turning to FIGS. 4A-4B, an exemplary method 400 for spoofing detection for Wi-Fi routers and/or wireless access points is shown. The method 400 may include many of the same steps as the method 300 for Wi-Fi routers or access points. That is, operation 402 involves receiving a first signal transmission performed by a Wi-Fi client in a network. Operation 404 involves analyzing characteristics of a beacon frame of the signal transmission. Operation 406 involves generating a ground truth fingerprint for the Wi-Fi client based on the characteristics. Operation 408 involves storing the ground truth fingerprint. Optional operations 410 and 412 involves receiving a second signal transmission and updating the ground truth fingerprint for the Wi-Fi client. Operation 414 involves receiving a third signal transmission including a MAC address that appears to be the same as the MAC address for the Wi-Fi client point for which the ground truth fingerprint was previously generated (the transmitting device could be the same device or may be a different device that is attempting to spoof the MAC address. Operation 416 involves generating a fingerprint for the device that transmitted the third signal. Optional operation 418 may involve recording data over time as a time series for signal transmission from the device. Operation 420 involves generating spoofing score(s), operation 422 involves comparing the spoofing score(s) to one or more threshold values, and operation 424 involves determining that the MAC address either or is not being spoofed based on the comparison.

The method 400 may differ from the method 300 in that the characteristics that are used for fingerprint generation may differ. The characteristics that are used for establishing a fingerprint for detecting spoofing of a Wi-Fi client may include elements of the following frames: “Data,” “QoS Data,” “Null,” “QoS Null,” “Data+CF-Ack,” and/or “QoS Data+CF-Ack”. For one or more of these frames, the system may analyze the following attributes: channel, wireless capabilities, message count statistics, and/or frame type distribution. These frames may also be analyzed to understand the wireless capabilities of the device. For instance, the information in the frames may be used to determine the wireless protocol(s) that the device is configured for (e.g., 802.11 a/b/g/ac/n, etc.).

FIG. 5 illustrates a method 500 for spoofing detection for paired Bluetooth devices. The system may detect spoofing of a paired Bluetooth device by, at operation 502, training a machine learning model (or any other type of model) to perform any of the analyses described above with respect to any of the scenarios (or any other types of communication protocols, devices, etc. not mentioned herein). The machine learning model may be used to generate the fingerprints (at operation 504) that are then stored as ground truth for known devices. An inference step then buffers subsequent data received from devices (at operation 506), establishes current fingerprints for the devices (at operation 508), and compares the current fingerprints to known fingerprints associated with the MAC addresses stored in memory to determine if a device is potentially spoofing its MAC address (at operation 510). It should be noted that the use of a machine learning model (or other type of model) is not necessarily limited to spoofing detection of Bluetooth devices and may also be used to detect spoofing of devices communicating via Wi-Fi (or any other communication protocol) as well.

FIG. 6 illustrates a method 600 for spoofing detection for unpaired Bluetooth devices. Operation 602 may involve receiving a first signal transmission from a known paired Bluetooth device. Operation 604 involves caching relevant attributes for each device (the attributes may also be stored in any other suitable storage mechanism. Operation 606 involves receiving a second signal transmission from the Bluetooth device. Operation 608 involves determining a change in the attributes from the first signal transmission transition.

In other words, the system may detect spoofing of an unpaired Bluetooth device by analyzing data received from devices and caching relevant attributes for each device. When the system detects a change in attributes, the device may be flagged as potentially spoofing its MAC address. The characteristics that are used for establishing a fingerprint for detecting spoofing of an unpaired Bluetooth device may include elements of Bluetooth FHS messages and BLE advertisements. The attributes of these frames may include, for example, device class, service, major category, minor category, device name, and/or device universally unique identifiers (UUIDs).

FIG. 7 depicts a block diagram of an example machine 700 upon which any of one or more techniques (e.g., methods) may be performed, in accordance with one or more example embodiments of the present disclosure. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuration may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a work assessment device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

It is understood that the above are only a subset of what the power converter control 719 may be configured to perform and that other functions included throughout this disclosure may also be performed by the power converter control 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method comprising:
receiving, using one or more processors, first communications from a first device, the first communications including a first MAC address for the first device;
determining, using one or more processors and based on the first communications, a first fingerprint associated with the first device;
receiving, using one or more processors, second communications from a second device, the second communications including a second MAC address for the second device;
determining, using one or more processors and based on the second communications, a second fingerprint associated with the second device;
determining, using the one or more processors, that the second MAC address is a same MAC address as the first MAC address;
comparing, using the one or more processors and based on determining that the first MAC address is a same MAC address as the second MAC address, the second fingerprint and the first fingerprint; and
determining, using the one or more processors and based on a difference between the first fingerprint and the second fingerprint, that the second MAC address is spoofed.

2. The method of claim 1, further comprising:
storing the first fingerprint and the first MAC address in memory.

3. The method of claim 1, wherein the first communications are Wi-Fi communications, and wherein the first fingerprint is based on data from a beacon frame.

4. The method of claim 3, wherein the data comprises at least one of: encryption data, authentication data, information element data, vendor specific information, vendor specific type information, channel, wireless capabilities, or message count statistics.

5. The method of claim 1, wherein the first communications are Wi-Fi communications, and wherein the first fingerprint is based on data from at least one of: a data frame, a quality of service (QoS) data frame, a null frame, a QoS null frame, a data+CF-Ack frame, or a QoS data+CF-Ack frame.

6. The method of claim 5, wherein the data comprises at least one of: channel, wireless capabilities, message count statistics, or frame type distribution.

7. The method of claim 1, wherein the first communications are Bluetooth communications, and wherein the first fingerprint is based on data from a Bluetooth data frame.

8. The method of claim 5, wherein the first communications are Bluetooth communications, and wherein the data comprises at least one of: frame size, message count, or interarrival times.

9. The method of claim 1, wherein the first communications are Bluetooth communications, and wherein the first fingerprint is based on data from a Bluetooth message or a Bluetooth Low Energy (BLE) advertisement.

10. The method of claim 7, wherein the data comprises at least one of: a device class, a service, a major category, a minor category, a device name, or a device universal unique identifier (UUID).

11. A system comprising:
memory that stores computer-executable instructions; and
one or more processors configured to access the memory and execute the computer-executable instructions to:
receive first communications from a first device, the first communications including a first MAC address for the first device;
determine, based on the first communications, a first fingerprint associated with the first device;
receive second communications from a second device, the second communications including a second MAC address for the second device;
determine, based on the second communications, a second fingerprint associated with the second device;
determine that the second MAC address is a same MAC address as the first MAC address;
compare, based on determining that the first MAC address is a same MAC address as the second MAC address, the second fingerprint and the first fingerprint; and
determine, based on a difference between the first fingerprint and the second fingerprint, that the second MAC address is spoofed.

12. The system of claim 11, wherein the one or more processors are further configured to execute the computer-executable instructions to:
store the first fingerprint and the first MAC address in memory.

13. The system of claim 11, wherein the first communications are Wi-Fi communications, and wherein the first fingerprint is based on data from a beacon frame.

14. The system of claim 13, wherein the data comprises at least one of: encryption data, authentication data, information element data, vendor specific information, vendor specific type information, channel, wireless capabilities, or message count statistics.

15. The system of claim 11, wherein the first communications are Wi-Fi communications, and wherein the first fingerprint is based on data from at least one of: a data frame, a quality of service (QoS) data frame, a null frame, a QoS null frame, a data+CF-Ack frame, or a QoS data+CF-Ack frame.

16. The system of claim 15, wherein the data comprises at least one of: channel, wireless capabilities, message count statistics, or frame type distribution.

17. The system of claim 11, wherein the first communications are Bluetooth communications, and wherein the first fingerprint is based on data from a Bluetooth data frame.

18. The system of claim 17, wherein the first communications are Bluetooth communications, and wherein the data comprises at least one of: frame size, message count, or interarrival times.

19. The system of claim 11, wherein the first communications are Bluetooth communications, and wherein the first fingerprint is based on data from a Bluetooth message or a Bluetooth Low Energy (BLE) advertisement.

20. The system of claim 19, wherein the data comprises at least one of: a device class, a service, a major category, a minor category, a device name, or a device universal unique identifier (UUID).
